(19) United States
(12) Patent Application Publication
(10) Pub. No.: US 2006/0141379 A1
(43) Pub. Date: Jun. 29, 2006

(54) Magnetic toner and image forming method using the same

(76) Inventors: Kouzou Teramoto, Osaka (JP); Yukinori Nakayama, Osaka (JP); Hiroshi Mizuhata, Wakayama-shi (JP); Kousuke Satou, Osaka (JP)

Correspondence Address: SMITH, GAMBRELL & RUSSELL, LLP, 1850 M STREET, N.W., SUITE 800, WASHINGTON, DC, 20036, US

(21) Appl. No.: 11/288,448

(22) Filed: Nov. 29, 2005

(30) Foreign Application Priority Data
Nov. 30, 2004 (JP) 2004-347198

(51) Int. Cl. G03G 9/083

(52) U.S. Cl. 430/106.2; 430/106.1; 430/125

(57) ABSTRACT

Magnetic toner involves magnetic powder 1 having the particle shape of an octahedron2 that is a convex polyhedron surrounded by eight triangles as a basis, each of the vertexes and edges of the octahedron being in a curved surface shape, and having a portion 3 that can be taken as a straight line on the outer periphery of its projected image. Therefore, the magnetic toner is superior in both two contradictory properties, that is, the property of making it easy for a charging amount to quickly rise as well as improving the charging amount and the property of preventing dielectric breakdown of the photosensitive layer of the amorphous silicon photoreceptor from occurring within a short period due to charge-up, thereby making it possible to form a good image under a wide environment. In an image forming method, an electrostatic latent image is developed into a toner image by a magnetic one-component jumping developing method using the magnetic toner.

### BACKGROUND OF THE INVENTION

The present invention relates to a magnetic toner and an image forming method using the same.

In image forming apparatuses such as laser printers, electrostatic copying machines, plain paper facsimiles, and their complex machines utilizing electrophotographic methods, etectrostatic recording methods, or electrostatic printing methods, a surface of a photoreceptor is uniformly charged by charging means, and is then exposed by exposure means such as semiconductor lasers or light-emitting diodes, to form an electrostatic latent image on the surface, and the electrostatic latent image is then developed into a toner image by developing means. The toner image is then directly transferred to a surface of a material to be printed such as paper by transfer means or is transferred to a surface of an intermediate transfer member, is then transferred again on the surface of the material to be printed such as paper, and is then fixed to the surface by fixing means, to complete a series of image forming steps.

Developing methods for developing an electrostatic latent image into a toner image are roughly divided into dry developing methods and wet developing methods. Currently, the dry developing methods have spread widely. The dry developing methods are classified into developing methods using magnetic toner having magnetic powder involved in its toner particles composed of binder resin (a magnetic one-component developing method, a magnetic two-components developing method, etc.) and developing methods using non-magnetic toner having no magnetic powder involved therein (a non-magnetic one-component developing method, a non-magnetic two-components developing method, etc.) when the-y are classified on the basis of the type of toner to be used.

In the magnetic one-component developing methods, the magnetic toner is supplied while forming a thin layer of the magnetic toner on a surface of a developer carrying member incorporating a fixed magnet, and the electrostatic latent image on the surface of the photoreceptor is then developed into the toner image by the thin layer of the magnetic toner. Examples of the magnetic one-component developing methods include developing methods using magnetic toner having conductive properties and developing methods called magnetic one-component jumping developing methods using magnetic toner having insulating properties. Currently, the latter magnetic one-component jumping developing methods have spread widely.

In the magnetic one-component jumping developing method, the magnetic toner is first supplied to a surface of the developer carrying member while being subjected to triboelectric charging by being passed through a clearance between the developer carrying member that is rotated and that is contained a fixed magnet therein and a magnetic blade disposed in close proximity to the developer carrying member, and is held by a magnetic force of the contained fixed magnet, to form a thin layer of the magnetic toner on the surface of the developer carrying member.

A direct current bias voltage or a bias voltage obtained by overlapping an alternating current with a direct current is applied between the photoreceptor for holding the electrostatic latent image and the developer carrying member that are opposed to each other with a clearance held therebetween so as not to come into contact with the formed thin layer, thereby scattering the charged magnetic toner on the surface of the photoreceptor from the thin layer, to develop the electrostatic latent image into a toner image.

In the magnetic one-component jumping developing method, the magnetic toner having insulating properties is used, so that transfer of the formed toner image on a surface of a material to be printed such as paper utilizing an electric field, which has been impossible in a case where toner having conductive properties is used, becomes possible. Further, the photoreceptor can be also prevented from being destroyed by electric leakage.

Further, the magnetic toner having insulating properties also has the following advantages:
the magnetic toner is easily charged,
the magnetic toner can be sufficiently rubbed against the developer carrying member in a state where magnetic toner is held by the magnetic force, and
the electrostatic latent image can be developed in a non-contact state with the electrostatic latent image while holding the magnetic toner by the magnetic force.

Therefore, an image superior in quality can be formed by preventing such fogging that toner adheres to a non-printed portion and a blank portion of the formed image.

The photoreceptor used in the magnetic one-component jumping developing method includes various organic and inorganic photoreceptors similar to the case of the other developing method. Considering the durability, a photoreceptor comprising a photosensitive layer made of an amorphous silicon (hereinafter, sometimes referred to as an “a-Si”) formed on a conductive base is preferably used. The a-Si photoreceptor has high durability in terms of the number of image-formed paper sheets, which is not less than about ten times higher than that of an organic photoreceptor comprising a photosensitive layer containing a pigment and a charge transporting material in a binder resin (hereinafter, sometimes referred to as an “organic photosensitive layer”). This is because the rate of decreasing the thickness of the a-si photosensitive layer, worn out by rubbing with a material to be printed and an elastic blade, is not more than about 1/100 times smaller than that of the organic photosensitive layer, and thus the a-si photosensitive layer is less likely to be worn out.

As cleaning means for removing the magnetic toner remaining on the surface of the photosensitive layer after transferring the toner image on the surface of a material to be printed such as paper, an elastic blade pressed against the surface of the photosensitive layer is preferably used considering downsizing of an image forming apparatus and simplification of a mechanism due to possible elimination of the movable portion.

The greater part of the magnetic toner remaining on the surface of the photosensitive layer after transferring the toner image on the surface of the material to be printed is scraped and removed from the surface of the photosensitive layer by using the elastic blade. However, a portion of the magnetic toner such as toner particles, fragments of magnetic powder and resin as well as a portion of external additives such as silica externally added to the magnetic toner so as to improve fluidity and charging properties are remained at the tip portion of the elastic blade, that is, the portion pressed against the photosensitive layer. When these remained materials are rubbed by the elastic blade and the photosensitive layer for a long period, the charge of the materials exceeds a designated value, and so-called charge-up arises. When the charging amount exceeds a critical value, that is, a proof voltage value of the photosensitive layer, discharging (one-point discharging) may occurs toward the microscopic region of the photosensitive layer to cause dielectric breakdown of the layer, and thus unrepairable defects may be formed. Discharging mainly occurs at the edge portion of the tip of the elastic blade.

The a-Si photosensitive layer is likely to cause dielectric breakdown because it intrinsically has low degree of tolerance to dielectric breakdown. Therefore, when image formation is repeated by the magnetic one-component jumping developing method using an a-Si photoreceptor comprising an a-Si photosensitive layer, an elastic blade and a magnetic toner, abnormal discharging (one-point discharging, spark discharging) occurs by the mechanism described above, and thus dielectric breakdown of the a-Si photosensitive layer may occurs and defects may be formed. When image formation is continuously conducted using the a-Si photoreceptor comprising the a-Si photosensitive layer including defects produced therein, a carrier blocking layer described hereinafter is broken at the defect portion and it is impossible to charge in the charging step, thus causing a problem that the formed image includes microscopic black dots produced therein.

The main cause of charge-up is the shape of a magnetic powder involved in the magnetic toner according to inventor's examination.

Generally used as the magnetic powder are currently magnetic powder in the shape of a polyhedron such as a hexahedron (a cube, a rectangular parallelepiped) that is a convex polyhedron surrounded by six quadrilaterals and an octahedron that is a convex polyhedron surrounded by eight triangles and magnetic powder in the shape of a sphere.

In the magnetic toner using the polyhedral magnetic powder, charges are easily discharged from pointed vertexes or pointed edges between adjacent faces of the magnetic powder exposed to surfaces of the toner particles. Therefore, even if the magnetic toner is remained at the tip portion of the elastic blade and is rubbed for a long time period, charged charges are discharged through the vertexes or edges before the a-Si layer causes dielectric breakdown, thus making it possible to prevent charge-up of the toner particles. Therefore, dielectric breakdown of the a-Si layer is less likely to occur.

However, in case of a magnetic toner using the spherical magnetic powder, since pointed vertexes or pointed edges between adjacent faces of the magnetic powder are not exposed to surfaces of the magnetic toner, charges are not easily discharged. Therefore, when the magnetic toner remains at the tip portion of the elastic blade and is rubbed for a long time period, charge-up easily occurs. When the charging amount exceeds a proof voltage value, dielectric breakdown of the a-Si layer occurs as described above, and thus the image-formed thereafter includes microscopic black dots produced therein.

Therefore, considering only the prevention of charge-up, it is preferred to use a polyhedral magnetic powder.

In the magnetic toner using the polyhedral magnetic powder, however, pointed vertexes or pointed edges between adjacent faces of the magnetic powder are exposed to surfaces of toner particles and charges are easily discharged therefrom, so that the charges are liable to leak. The polyhedral magnetic powder is low in fluidity and is inferior in dispersibility to binder resin. Accordingly, it is difficult to uniformly disperse the magnetic powder in the binder resin. Therefore, there easily occur variations in the dispersed state and the content of the magnetic powder among the toner particles, so that the magnetic toner also easily varies in the ease of charging, the charging amount, and so on.

In the magnetic toner using the polyhedral magnetic powder, therefore, the charging amount does not easily rise quickly, and the charging amount itself is small. As a result, image defects such as decrease in image density and occurrence of fogging are liable to occur. Further, the magnetic toner easily varies in the ease of charging and the charging amount depending on the temperature and humidity environments at the time of image formation. Particularly under environments, where charging is difficult, such as high-temperature and high-humidity environments, the above-mentioned image defects are liable to further occur.

On the other hand, the spherical magnetic powder has no pointed vertexes and edges. In the magnetic toner using the spherical magnetic powder, therefore, charges are not easily discharged from the magnetic powder exposed to the surfaces of the toner particles, so that the charges do not easily leak. The spherical magnetic powder is superior in fluidity and is also superior in dispersibility to the binder resin compared with the polyhedral magnetic powder. Accordingly, the magnetic powder is easy to uniformly disperse in the binder resin. Therefore, the magnetic powder can be made uniform in the ease of charging, the charging amount, and so on by preventing variations in the dispersed state of the magnetic powder from occurring among the toner particles.

In the magnetic toner using the spherical magnetic powder, however, charges are conversely too easily stored. Therefore, there occurs so-called charge-up in which the magnetic toner is charged in excess of not less than a predetermined charging amount in cases such as a case where the magnetic toner is repeatedly rubbed in a clearance between the developer carrying member and the magnetic blade. When the charge-up occurs, image defects represented by decrease in image density rather easily occurs.

In order to make use of both the respective advantages of the spherical magnetic powder and the polyhedral magnetic powder, therefore, magnetic powders having various particle shapes have been examined.

The following documents, for example, disclose magnetic powders each having the particle shape of a polyhedron such as a hexahedron or an octahedron, whose vertexes and edges are each subjected to so-called chamfering at a plane smaller than each of faces constituting the polyhedron.
Japanese Unexamined Patent Publication No. JP11-153882A (1999)
Japanese Unexamined Patent Publication No. JP2000-162817A

Japanese Unexamined Patent Publication No. JP2000-242029A.

In the magnetic powders disclosed in the documents, however, pointed edges still exists between the face composing the polyhedron and the small plane used for the chamfering. Charges are easily discharged from the edges. Accordingly, the charges are liable to leak from the magnetic toner, so that image defects such as decrease in image density and occurrence of fogging may occur.

### SUMMARY OF THE INVENTION

An object of the present invention is to provide magnetic toner superior in both two contradictory properties, that is, the property of making it easy for a charging amount to quickly rise as well as to be improving the charging amount and the property of preventing dielectric breakdown of the a-si photosensitive layer from occurring within a short period due to charge-up thereby making it possible to form a good image under a wide environment during a long time period, and an image forming method using the same.

In order to solve the above-mentioned problems, the inventors have examined the use of magnetic powder having the particle shape of an octahedron that is a convex polyhedron surrounded by eight triangles as a basis, each of the vertexes and edges of the octahedron being in a curved surface shape.

The magnetic powder having the above-mentioned particle shape has vertexes and edges in a curved surface shape and does not have pointed vertexes and edges from which charges are easily discharged. Therefore, the magnetic powder can make it more difficult for charges to leak in a case where it is involved in magnetic toner, as compared with the magnetic powders each having the shape of a polyhedron, whose vertexes and edges are each chamfered at a small plane, as disclosed in the documents.

The magnetic powder is superior in fluidity and dispersibility to binder resin because any of the vertexes and edges of the polyhedron is in a curved shape, as described above. Accordingly, the magnetic powder is easy to uniformly disperse in the binder resin. Therefore, the magnetic powder can be made uniform in the ease of charging, the charging amount, and so on by preventing variations in the dispersed state of the magnetic power from occurring among toner particles.

Moreover, the basic shape of the magnetic powder is an octahedron. Accordingly, the adjacent faces, with any one of the vertexes or the edges interposed therebetween or the adjacent edges with any one of the vertexes interposed therebetween both constitute the octahedron always cross at acute angles of less than 90 degrees. Although both of the vertexes at which the faces or the edges cross at acute angles and the edges at which the faces cross at acute angles are each in a curved surface shape, charges are easily concentrated. Therefore, the charges can be discharged at a proper rate from the vertexes or edges, thereby making it difficult to cause charge-up to occur in case the magnetic powder is involved in the magnetic toner, and thus dielectric breakdown of the a-si photosensitive layer can be prevented.

Even if the particle shape is the above-mentioned octahedron, however, the effect of preventing dielectric breakdown of the a-si photosensitive layer thereby to prevent the charge-up of the magnetic toner by discharging charges at a proper rate from the vertexes or edges in a curved surface shape is not obtained when the respective radii of curvature of the vertexes and edges are too large. Therefore, the inventors have considered that the respective ranges of the radii of curvature of the vertexes and edges in a curved surface shape are defined from a projected image of magnetic powder picked up using a transmission electron microscope (TEM) or the like.

As a result, the inventors have found out that magnetic powder having the shape of an octahedron, whose vertexes and edges are each in a curved surface shape, and having a portion that can be taken as a straight line on the outer periphery of its projected image allows charges to be discharged at a proper rate from the vertexes or edges at which charges are easily concentrated and allows charge-up of magnetic toner to be prevented while making it more difficult for the charges to leak, as compared with magnetic power, whose vertexes and edges are not each in a curved surface shape, and thus dielectric breakdown of the a-si photosensitive layer can be prevented.

That is, magnetic powder having a shape close to a spherical shape not having a portion that can be taken as a straight line on the outer periphery of its projected image because the vertexes and edges in a curved surface shape have too large radii of curvature so that adjacent curved faces connect with each other cannot give the effect of preventing the charge-up of the magnetic toner thereby to prevent dielectric breakdown of the a-si photosensitive layer, similarly to spherical magnetic powder.

On the other hand, in magnetic powder having the shape of an octahedron, whose vertexes and edges are each in a curved surface shape, and having a portion that can be taken as a straight line on the outer periphery of its projected image, the edges and the vertexes at which the adjacent faces cross are composed of a curved surface, and the radius of curvature of the curved face is smaller than the radius of curvature of spherical magnetic powder having the same particle diameter, so that charges can be discharged at a proper rate from the vertexes or the edges at which charges are easily concentrated.

Therefore, the magnetic powder makes it possible to prevent the charge-up of the magnetic toner while making it more difficult for charges to leak when it is involved in the magnetic toner, as compared with the magnetic powder, whose vertexes and edges are not each in a curved surface shape, and thus it becomes possible to prevent dielectric breakdown of the a-si photosensitive layer.

The inventors have also examined the size of the magnetic powder. Aks a result, they have found out that the average particle diameter of the magnetic powder must be 0.01 to 0.50 μm due to the following problems:
(1) In magnetic powder having an average particle diameter of less than 0.01 μm, the ratio of the magnetic powder exposed to surfaces of toner particles is increased, and charges are discharged from the exposed magnetic powder, causing deficiency in charging of the magnetic toner, resulting in lowered image density.
(2) On the other hand, in magnetic powder having an average particle diameter exceeding 0.50 μm, the ratio of the magnetic powder exposed to surfaces of toner particles is reduced, and charges discharged from the exposed magnetic powder are reduced, causing charge-up of the magnetic toner, resulting in lowered image density particularly when image formation is repeated, and also dielectric breakdown of the a-si photosensitive layer can not be prevented.

Consequently, the present invention provides magnetic toner to be used for an image forming method comprising the step of using an a-si photoreceptor comprising a photosensitive layer formed of an a-si for holding an electrostatic latent image on the surface, which is used to develop an electrostatic latent image held on the surface of the photosensitive layer into a toner image and to transfer the toner image on the surface of a material to be printed to form an image, and an elastic blade pressed against the surface of the photosensitive layer so as to remove a toner remaining on the surface of the photosensitive layer after forming the image, wherein characterized in that toner particles formed of binder resin involves magnetic powder having an average particle diameter of 0.01 to 0.5 μm, and having the particle shape of an octahedron that is a convex polyhedron surrounded by eight triangles as a basis, each of the vertexes and edges of the octahedron being in a curved surface shape, and having a portion that can be taken as a straight line on the outer periphery of its projected image.

Considering that the effect of preventing the foregoing problems (1) and (2) from arising is further improved, it is preferable that the average particle diameter of the magnetic powder is particularly 0.05 to 0.35 μm in the above-mentioned range. Considering that good magnetic properties are provided to the magnetic toner, it is preferable that used as the magnetic powder is formed of magnetite (triiron tetroxide) containing at least one type of element selected from Mn, Zn, Ni, Cu, Al, Ti, and Si that is 0.1 to 10 atom % of Fe. From the same reason, it is preferable that the content of the magnetic powder in the toner particles is 35 to 60 mass %.

The magnetic toner of the present invention is preferably used for an image forming method of using an a-Si photoreceptor comprising a photosensitive layer having a thickness of 30 μm or less. The maximum demerit of the a-Si photoreceptor lies in low productivity. That is, the a-Si photoreceptor is produced by forming an a-Si photosensitive layer on a conductive base using a vapor deposition method such as CVD method. However, according to the vapor deposition method, it takes a very long time to form a photosensitive layer having a predetermined thickness as compared with an organic photosensitive layer which can be formed only by applying a coating solution containing a binder resin or the like on a conductive base and drying the coating solution. Also the vapor deposition method is a batch type method and is not capable of producing a product continuously, resulting in low productivity.

Therefore, there has been made a trial of improving productivity of the a-Si photoreceptor by decreasing the thickness of the a-si photosensitive layer, utilizing the fact that the a-Si photosensitive layer is not easily worn out as compared with the organic photosensitive layer. Currently, an a-Si photoreceptor comprising a thin-film type a-Si photosensitive layer, whose thickness is reduced to 30 μm or less from a conventional thickness of about 30 to 60 μm, has begun to spread. It is needless to say that main merit of the thin-film type a-Si photosensitive layer is that it is excellent in productivity as compared with a conventional one, and also there is such a merit that resolution of the formed image is improved when the thickness of the layer is decreased.

However, since the a-Si photosensitive layer intrinsically has low degree of tolerance to dielectric breakdown and shows a low proof voltage value as compared with a conventional one, dielectric breakdown more easily occurs in case of a thin-film type. That is, the occurrence of defects of the a-Si photo sensitive layer due to dielectric breakdown greatly depends on a stylus proof voltage (V), and the smaller the thickness of the a-Si photosensitive layer, defects due to dielectric breakdown are formed more easily. Therefore, when an a-Si photoreceptor comprising a thin-film type a-Si photosensitive layer, an elastic blade and a conventional magnetic toner containing a spherical magnetic powder are used in combination, the a-Si photosensitive layer may cause dielectric breakdown within a very short time period due to charge-up.

When the a-Si photoreceptor comprising the thin-film type a-Si photosensitive layer is used in combination with the magnetic toner having excellent effect of preventing charge-up of the present invention, it becomes possible to more continuously form a good image for a long time period by prevention of dielectric breakdown of the a-Si photosensitive layer within a short time due to charge-up while making use of the merit of the thin-film type a-Si photosensitive layer such as excellent in productivity and formation of an image with high resolution.

The present invention provides an image forming method comprising the steps of: forming a thin layer of the magnetic toner of claim 1 on a surface of a developer carrying member that is rotated and that is contained a fixed magnet therein; scattering the magnetic toner on a surface of an a-si photoreceptor comprising a photosensitive layer formed of an a-si for holding an electrostatic latent image from the thin layer in a state where the developer carrying member and the photosensitive layer are opposed to each other with a clearance held therebetween such that the thin layer and the surface of the photosensitive layer are not brought into contact with each other, to develop the electrostatic latent image into a toner image; transferring the toner image thus formed on the surface of a material to be printed; and removing the magnetic toner remaining on the surface of the photosensitive layer after transferring on the surface of the material to be printed, using an elastic blade pressed against the surface of the photosensitive layer.

In the image forming method of the present invention, an a-Si photoreceptor comprising a photosensitive layer having a thickness of 30 μm or less is preferably used as the a-Si photoreceptor.

### BRIEF DESCRIPTION OF DRAWINGS

FIG. 1 is a perspective view schematically showing the shape of magnetic powder contained in magnetic toner according to the present invention;

FIG. 2 is an electron magnetograph showing an example of the magnetic powder shown in FIG. 1; and

FIG. 3 is a diagram showing a projected image of the magnetic powder shown in FIG. 2 in simplified fashion;

### DETAILED DESCRIPTION OF THE PREFERRED EMBODIMENTS

<<Magnetic Toner>>

<Magnetic Powder>

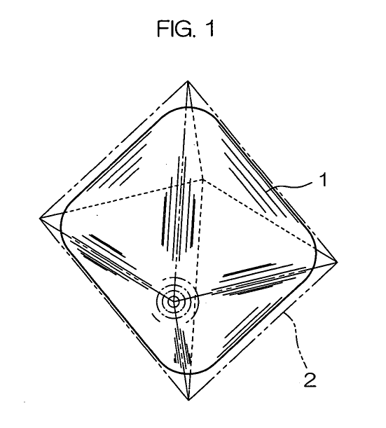

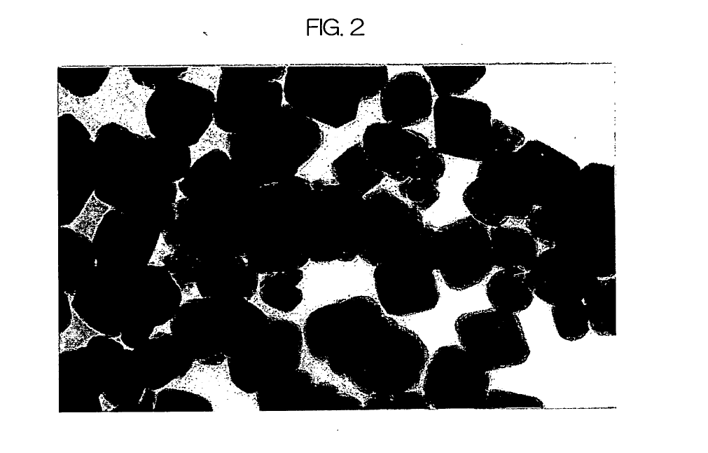

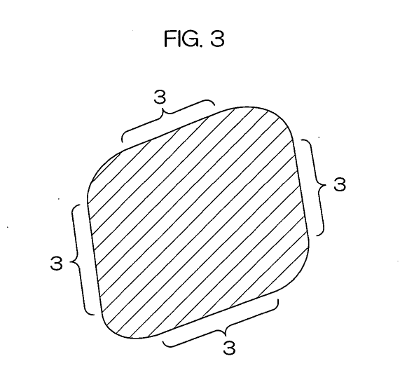

Used as magnetic powder 1 is magnetic powder having the particle shape of an octahedron 2 that is a convex polyhedron surrounded by eight triangles, indicated by a two-dot and dash line and a broken line in FIG. 1, as a basis, each of the vertexes and edges of the octahedron 2 being in a curved surface shape, as indicated by a solid line in FIG. 1, and having a portion 3 that can be taken as a straight line on the outer periphery of a picture (a projected image) taken using a transmission electron microscope (TEM), as shown in FIG. 2, for example, as also shown in FIG. 3 showing the projected image in simplified fashion.

The magnetic powder 1 does not cause charges to leak when it is involved in magnetic toner, and is superior in fluidity and dispersibility to binder resin and is easy to uniformly disperse in binder resin, as previously described, because it has no pointed vertexes and edges serving as points at which charges are discharged. Therefore, the magnetic toner can be made uniform in the ease of charging, the charging amount, and so on by preventing variations in the dispersed state of the magnetic powder from occurring among toner particles.

Since the basic shape of the magnetic powder 1 is an octahedron, adjacent faces with any one of the vertexes or edges interposed therebetween or adjacent edges with any one of the vertexes interposed therebetween both constitute the octahedron always cross at acute angles of less than 90 degrees. Charges are easily concentrated on the vertexes at which the adjacent faces or edges cross at acute angles or the edges at which the adjacent faces cross at acute angles. Moreover, the magnetic powder 1 has the portion 3 that can be taken as a straight line on the outer periphery of the projected image, and the edges and the vertexes, at which the adjacent faces cross, of the octahedron is composed of a curved surface. However, the radius of curvature of the curved surface is smaller than the radius of curvature of spherical magnetic powder having the same particle diameter as that of the octahedral magnetic powder. Therefore, the magnetic powder 1 allows charges to be discharged at a proper rate from the vertexes or the edges at which charges are easily concentrated.

The magnetic powder 1 must have an average particle diameter of 0.01 to 0.50 μm. In magnetic powder having an average particle diameter of less than 0.01 μm, the ratio of the magnetic powder exposed to surfaces of toner particles is increased, and charges are discharged from the exposed magnetic powder, causing deficiency in charging of magnetic toner, resulting in lowered image density.

On the other hand, in magnetic powder having an average particle diameter exceeding 0.50 μm, the ratio of the magnetic powder exposed to surfaces of toner particles is reduced, and an amount of charges discharged from the exposed magnetic powder is reduced, causing charge-up of magnetic toner, resulting in lowered image density particularly when image formation is repeated.

Considering that the effect of preventing the problems from arising is further improved, the average particle diameter of the magnetic powder is preferably 0.05 to 0.35 μm and more preferably 0.15 to 0.30 μm particularly in the above-mentioned range.

The average particle diameter of the magnetic powder is the average value of the Martin's diameters (diameters corresponding to a circle) of 300 magnetic powders appearing on a picture obtained by magnifying an electron magnetograph (×10000 magnification) taken by a transmission electron microscope four times.

Examples of the magnetic powder include:
a metal exhibiting ferromagnetism such as iron, cobalt, nickel, or its alloy, or a compound containing these elements,
an alloy containing no ferromagnetic element but exhibiting ferromagnetism by performing suitable heat treatment, or chromium dioxide.

Among them, magnetic powder formed of ferrite or magnetite is preferable. Particularly considering that good magnetic properties are provided to magnetic toner, it is preferable that the magnetic powder formed of magnetite containing at least one type of element selected from Mn, Zn, Ni, Cu, Al, Ti, and Si that is 0.1 to 10 atom % of Fe.

The magnetic powder composed of the magnetite, having the shape of an octahedron, whose vertexes and edges are each in a curved surface shape, having a portion that can be taken as a straight line on the outer periphery of its projected image, and having an average particle diameter defined within the range previously described can be produced by the following method, for example.

That is, 26.7 liters of an aqueous solution of a ferrous sulfate salt containing 1.5 mol/liters of Fe^{2 +} is added to 25.9 liters of a 3.4 N sodium hydroxide solution (corresponding to an equivalent amount of 1.10 with respect to Fe²⁺) that has been contained in a reaction chamber in advance, and are heated to 90° C., to produce a ferrous-salt suspension containing a ferrous hydroxide colloid while maintaining the pH at 10.5.

100 liters per minute of air is blown in for 80 minutes while maintaining the liquid temperature of the suspension at 90° C., to perform oxidation reaction until the oxidation reaction ratio of a ferrous salt amounts to 60%.

A sulfate solution is added to the suspension such that the pH thereof becomes 6.5, and 100 liters per minute of air is then blown in for 50 minutes while maintaining the liquid temperature at 90° C., to produce magnetite particles in the suspension.

A sodium hydroxide solution is added to the suspension containing the magnetite particles such that the pH thereof becomes 10.5, and 100 liters per minute of air is then blown in for 20 minutes while maintaining the liquid temperature at 90° C., and produced magnetite particles are rinsed, filtered, and dried, to grind an aggregation of the magnetite particles. Consequently, magnetic powder composed of the magnetite particles having the particle shape of an octahedron as a basis, each of the vertexes and edges of the octahedron being in a curved surface shape, is synthesized.

When the above-mentioned synthetic reaction is performed, various types of water-soluble metal compounds such as a water-soluble silicate is added to an alkali hydroxide solution or a ferrous salt reaction solution containing a ferrous hydroxide colloid at a ratio of 0.1 to 10 atom % to Fe in terms of each of metals, and the pH of the solution in a case where blowing of oxygen-containing gas(e.g. air) is started is adjusted to 8.0 to 9.5 in the reaction in the first stage, the magnetic powder to be synthesized is composed of magnetite containing at least one type of element selected from Mn, Zn, Ni, Cu, Al, Ti, and Si at the above-mentioned predetermined ratio to Fe.

The ratio of the magnetic powder in the toner particles is preferably 35 to 60 mass % and more preferably 35 to 55 mass %. When the ratio of the magnetic powder is less than this range, the effect of holding a thin layer of the magnetic toner on a surface of the developer carrying member by a magnetic force of a fixed magnet contained in the developer carrying member is weakened, so that fogging may occur particularly when image formation is repeated. When the ratio of the magnetic powder exceeds this range, the effect of holding the thin layer of the magnetic toner on the surface of the developer carrying member is conversely made too strong, so that image density may be reduced. Since the ratio of the binder resin is relatively lowered, the fixing properties of the magnetic toner to a surface of a material to be printed such as paper and the durability thereof may be degraded.

Considering that the magnetic powder is satisfactorily dispersed in the binder resin, it may be subjected to surface treatment using surface treating agents such as a titanium coupling agent, a silane coupling agent, aluminum coupling agent, and various types of fatty acids. Among them, the silane coupling agent is preferable. Examples of a specific compound of the silane coupling agent include hexamethyldisilazane, trimethylsilane, trimethylchlorosilane, trimethyl ethoxysilane, dimethyldichlorosilane, methyltrichlorosilane, allyldimethylchlorosilane, allylphenyldichlorosilane, benzyldimethylchlorosilane, bromomethyldimethylchlorosilane, α-chlorethyltrichlorosilane, β-chlorethyltrichlorosilane, chloromethyldimethylchlorosilane, triorganosilylmercaptan, trimethylsilylmercaptan, triorganosilylacrylate, vinyldimehyl acetoxysilane, dimethyl diethoxysilane, dimethyl dimethoxysilane, diphenyl ethoxysilane, hexamethyldisiloxane, 1,3-divinyl tetramethyldisiloxane, and 1,3-diphenyl tetramethyldisiloxane. Further, it is also possible to use dimethyl polysiloxane having two to twelve siloxane units per one molecule and containing hydroxyl groups respectively coupled to silicon atoms in the siloxane unit positioned at its end.

<Binder Resin>

Examples of the binder resin include polystyrene resins, acrylic resins, polyethylene resins, polypropylene resins, polyvinyl chloride resins, polyester resins, polyamide resins, polyurethane resins, polyvinyl alcohol resins, vinyl ether resins, N-vinyl resins, and styrene-butadiene resins. Particularly, polystyrene resins and polyester resins are preferable.

Examples of the polystyrene resins include a binary or ternary copolymer or a copolymer having four or more elements of styrene and another monomer in addition to a homopolymer of styrene. Examples of other monomers that can be copolymerized with styrene include one type or two or more types of p-chlorostyrene; vinyl naphthalene; ethylene unsaturated monoolefins such as ethylene, propylene, butylenes, and isobutylene; halogenated vinyls such as vinyl chloride, vinyl bromide, and vinyl fluoride; vinyl esters such as vinyl acetate, vinyl propionate, vinyl benzoate, and vinyl butyrate; (meth-)acrylic esters such as methyl acrylate, ethyl acrylate, n-butyl acrylate, isobutyl acrylate, dodecyl acrylate, n-octyl acrylate, 2-chloroethyl acrylate, phenyl acrylate, α-chloro methyl acrylate, methyl methacrylate, ethyl methacrylate, and butyl methacrylate; other acrylic acid derivatives such as acrylonitrile, methacrylonitrile, and acrylamide; vinyl ethers such as vinyl methyl ether and vinyl isobutyl ether; vinyl ketons such as vinyl methyl ketone, vinyl ethyl ketone, and methyl isopropenyl ketone; N-vinyl compounds such as N-vinyl pyrrole, N-vinyl carbazole, N-vinyl indole, N-vinyl pyrrolidone, and so on.

Examples of the polyester resin include various types of polyester resins obtained by condensation polymerization or co-condensation polymerization of an alcohol component and a carboxylic acid component. Examples of the alcohol component include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,4-cyclohexanedimethanol, dipropylene glycol, polyethylene glycol, polypropylene glycol, polytetramethylene glycol, 1,6-hexanediol, and 1,8-octanediol; bisphenols such as bisphenol A, hydrogenated bisphenol A, polyoxyethylenated bisphenol A, and polyoxypropylenated bisphenol A; alcohols having three or more hydroxyl groups such as sorbitol, 1,2,3,6-hexanetetrol, 1,4-sorbitan, pentaerythritol, dipentaerithritol, tripentaerythritol, 1,2,4-butanetriol, 1,2,5-pentanetriol, glycerin, diglycerin, 2-methylpropanetriol, 2-methyl-1,2,4-butanetriol, trimethylolethane, trimethylolpropane, 1,3,5-trihydroxymethylbenzene; and so on.

Examples of the carboxylic acid component include acids having two carboxyl groups such as oxalic acid, maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkyl succinic acid (n-butyl succinic acid, isobutyl succinic acid, n-octyl succinic acid, n-dodecyl succinic acid, isododecyl succinic acid, etc.), alkenyl succinic acid (n-butenyl succinic acid, isobutenyl succinic acid, n-octenyl succinic acid, n-dodecenylsuccinic acid, isododecenylsuccinic acid, etc.); and acids having three or more carboxyl groups such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylene carboxypropane, 1,2,4-cyclohexanetricarboxylic acid, tetra (methylene carboxyl) methane, 1,2,7,8-octanetetracarboxylic acid, pyromellitic acid, and enpol trimer acid; and so

Considering that the magnetic toner according to the present invention is satisfactorily fixed to a surface of a material to be printed such as paper by heat fixing means used in a normal image forming apparatus, the softening point of polyester resin is preferably 80 to 150° C. and more preferably 90 to 140° C.

It is preferable that a part of the binder resin has a cross-linking structure. Preservation stability and form holding properties, durability, and so on of the magnetic toner can be improved without degrading fixing properties by introducing a cross-linking structure into a part of the binder resin. In order to cause a part of the binder resin to have a cross-linking structure, a cross-linking agent may be added to crosslink the resin, or thermosetting resin may be blended.

Examples of the thermosetting resin include one type or two or more types of epoxy resins such as bisphenol A-type epoxy resin, hydrogenated bisphenol A-type epoxy resin, novolac-type epoxy resin, polyalkylene ether-type epoxy resin, and cyclic aliphatic-type epoxy resin; cyanate resin; and so on.

The glass transition temperature Tg of the binder resin is preferably 50 to 65° C. and more preferably 50 to 60° C. In a case where the glass transition temperature is less than this range, toner particles may be easily welded to one another, so that preservation stability may be degraded. Further, the strength of the resin is low, so that there may occur such a phenomenon that the resin adheres to a surface of a photoreceptor, not to be separated therefrom, so-called toner adhesion. Conversely, when the glass transition temperature exceeds this range, the fixing properties to a surface of a material to be printed such as paper may be degraded.

The glass transition temperature of the binder resin can be found from a change point of specific heat in an endothermic curve measured using a differential scanning calorimeter (DSC), for example. Specifically, the glass transition temperature of the binder resin can be found from a change point of specific heat in an obtained endothermic curve by putting 10 mg of a measuring sample in an aluminum pan using a differential scanning calorimeter DSC-6200 manufactured by Seiko Instruments Inc., for example, as well as using a hollow aluminum pan as a reference to make measurements under normal temperature and normal pressure in a measurement temperature range of 25 to 200° C. and at a temperature rise speed of 10° C./min.

Various types of additives conventionally known such as a coloring agent, a charge-controlling agent and waxes can be also contained in the magnetic toner according to the present invention. Examples of the coloring agent include pigments such as carbon black and dyes such as Acid Violet. It is preferable that the ratio of the coloring agent in the toner particles is 0.5 to 5 mass %.

<Charge-controlling Agent>

A charge-controlling agent is blended in order to improve the charging level of the magnetic toner and the charging rise characteristics thereof (an index indicating whether or not the magnetic toner is charged at a predetermined charge level in a short time period) as well as to improve durability and stability. Examples of the charge-controlling agent include one having positive charging properties and one having negative charging properties. Either one of them is blended in conformity with the charging polarity of the magnetic toner.

Examples of the charge-controlling agent having positive charging properties include one type or two or more types of azine compounds such as pyridazine, pyrimidine, pyrazine, ortho-oxazine, meta-oxazine, para-oxazine, ortho-thazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds such as azine FastRed FC, azine FastRed 12BK, azine Violet BO, azine Brown 3G, azine Light Brown GR, azine Dark Green BH/C, azine Deep Black EW, and azine Deep Black 3RL; nigrosine compounds such as nigrosine, a nigrosine salt, and a nigrosine derivative; acid dyes composed of nigrosine compounds such as nigrosine BK, nigrosine NB, and nigrosine Z; metal salts of naphthenic acid or higher fatty acid; alkoxylated amine; alkylamido; quaternary ammonium salts such as benzylmethylhexyldecylammonium, and decyltrimethylammonium chloride; and so on. Particularly, the nigrosine compound is suitable as toner having positive charging properties because more quick charging rise characteristics are obtained.

Usable as the charge-controlling agent having positive charging properties are also resin or oligomer having a quaternary ammonium salt, resin or oligomer having a carboxylate salt, resin or oligomer having a carboxyl group, and so on. Specifically, examples are one type or two or more types of polystyrene resin having a quaternary ammonium salt, acrylic resin having a quaternary ammonium salt, styrene-acrylic resin having a quaternary ammonium salt, polyester resin having a quarternary ammonium salt, polystyrene resin having a carboxylate salt, acrylic resin having a carboxylate salt, styrene-acrylic resin having a carboxylate salt, polyester resin having a carboxylate salt, polystyrene resin having a carboxyl group, acrylic resin having a carboxyl group, styrene-acrylic resin having a carboxyl group, polyester resin having a carboxyl group, and so on.

Particularly, styrene-acrylic resin (a styrene-acrylic copolymer) having a quaternary ammonium salt, a carboxylate salt, or a carboxyl group as a functional group is suitable because the charging amount thereof can be easily adjusted to a value within a desired range. Examples of acrylic monomers, together with styrene, composing styrene-acrylic resin include alkyl (meth-acrylate esters such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate, and isobutyl methacrylate.

Furthermore, used as the quaternary ammonium salt compound is a unit to be induced from dialkylaminoalkyl (meth-)acrylate via quaternization. Examples of the dialkylaminoalkyl (meth-)acrylate to be induced include di (lower alkyl) aminoethyl (meth-)acrylates such as dimethylaminoethyl (meth-)crylate, diethylaminoethyl (meth-)crylate, dipropylaminoethyl (meth-)crylate, and dibutylaminoethyl (meth-)crylate; dimethylmethacrylamido; and dimethylaminopropylmethacrylamido. Further, polymerizable monomers containing a hydroxyl group such as hydroxyehtyl (meth-)crylate, hydroxypropyl (meth-)crylate, 2-hydroxybutyl (meth-)crylate, and N-methylol (meth-)crylamido can be simultaneously used at the time of polymerization.

Effective as the charge-controlling agent having negative charging properties are organic metal complexes and chelate compounds, for example. Among them, an acetylacetone metal complex, a salicylic acid metal complex, or a salt is preferable. Particularly, the salicylic acid metal complex or the salt is preferable. Examples of the acetylacetone metal complex include aluminum acetylacetonate and iron (II) acetylacetonate. Examples of the salicylic acid metal complex or the salt include chromium 3,5-di-tert-butyl salicylate.

The ratio of the charge-controlling agent in the toner particles is preferably 0.5 to 15 mass %, and more preferably 0.5 to 8.0 mass %, and particularly preferably 0.5 to 7.0 mass %. When the ratio of the charge-controlling agent is less than this range, it is difficult to provide stable charging properties to the magnetic toner, so that image density may be lowered, and durability may be degraded. Conversely, when the ratio exceeds this range, inferior charging and inferior images are liable to occur under environmental resistance of the magnetic toner and particularly, under a high-temperature and high-humidity environment, and inferior dispersion in the binder resin is liable to occur. The inferior dispersion may cause fogging. Further, the charge-controlling agent that has aggregated without being dispersed may contaminate a photoreceptor.

<Wax>

Wax is blended in order to improve the fixing properties of the magnetic toner on a surface of a material to be printed such as paper, prevent such offset that the magnetic toner at the time of fixing adheres to a fixing roller or the like in an image forming apparatus to improve offset resistance, and prevent such image smearing that the magnetic toner that has adhered to the fixing roller or the like adheres to the surface of the material to be printed again to make images dirty.

As the wax, one type or two or more types of olefin waxes such as polyethylene wax and polypropylene wax; vegetable waxes such as carnauba wax, rice wax, and candelilla wax; mineral waxes such as montan wax; Fisher-Tropsch waxes produced by a Fisher-Tropsch method from coal, natural gas, etc.; petroleum waxes such as paraffin wax and microcrystalline wax; ester waxes; Teflon® waxes, etc., for example, can be selected and used.

It is preferable that the ratio of the wax in the toner particles is 1 to 5 mass %. In a case where the ratio of the wax is less than this range, the effect of improving anti-offset properties of magnetic toner and preventing image smearing may be insufficient. Conversely, in a case where the ratio of the wax exceeds this range, toner particles may be welded to one another to reduce preservation stability.

<Production of Magnetic Toner>

The magnetic toner according to the present invention is produced by mixing the foregoing components using an agitating and mixing machine such as a Henschel mixer, then kneading them using a kneading machine such as an extruder, followed by cooling, and further grinding as well as classifying them as required. The foregoing components may be wet-mixed. It is preferable that the center particle diameter on the volume basis of the magnetic toner according to the present invention thus produced is 5 to 10 μm.

In order to improve fluidity, preservation stability, cleaning properties indicating ease of cleaning and removal from a surface of a photoreceptor, and so on, its surface may be subjected to surface treatment using fine particles of colloidal silica, hydrophobic silica, alumina, titanium oxide, or the like (an external additive, generally having an average particle diameter of not more than 1.0 μm), for example, as required. In the surface treatment, it is preferable that the magnetic toner and the external additive are dry-mixed. Particularly in order to prevent the external additive from being embedded in surfaces of toner particles, they are preferably mixed using a Henschel mixer, a Nauter mixer, or the like. It is preferable that the amount of addition of the external additive to the toner particles is 0.2 to 10.0 mass %. Further, the external additive may be subjected to surface treatment using aminosilane, silicone oil, a silane coupling agent (hexamethyldisilazane, etc.), a titanium coupling agent, or the like, as required.

As described above, the magnetic toner of the present invention is used in combination with an a-Si photoreceptor to form an image, and is superior in both two contradictory properties, that is, the property of making it easy for a charging amount to quickly rise as well as improving the charging amount and the property of preventing dielectric breakdown of an a-Si photosensitive layer from occurring within a short period due to charge-up, and thus a specific effect capable of continuously forming a good image for a longer time period under a wide environment can be exerted.

<a-Si Photoreceptor>

As an a-Si photoreceptor, a photoreceptor comprising an a-Si photosensitive layer formed on a conductive base formed into a predetermined shape such as drum or the like is used. It is particularly preferable to use a photoreceptor comprising a thin-film type a-Si photosensitive layer having a thickness of 30 μm or less.

The a-Si photosensitive layer may have a carrier blocking layer and a surface protective layer, in addition to a single-layer or a multi-layer composed of two or more layers which actually functions as a photosensitive layer. In case of an a-Si photosensitive layer having the multi-layer structure, the total thickness is preferably 30 μm or less. As described above, the a-Si photoreceptor having such a thin-film type a-Si photosensitive layer has such an advantage that it is excellent in productivity and formation of an image with high resolution.

Described in detail, when the thickness of the a-Si photosensitive layer is more than 30 μm, since a drift speed of heat carriers increases, dark decay characteristics deteriorate and latent image blurring of the a-Si photosensitive layer in a facial direction perpendicular to the thickness direction easily occurs, resulting in, lowered resolution of the image. Since the time required to form the layer by a vapor deposition method increases and thus the probability that foreign matters adhere increases and yiels falls, resulting in low productivity of the a-Si photoreceptor. On the other hand, when the thickness of the a-Si photosensitive layer is 30 μm or less, since the occurrence of latent image blurring is suppressed, an image with high resolution can be obtained. Also, since the film-forming time decreases and good yield is attained, productivity of the a-Si photoreceptor is improved.

The thickness of the a-Si photosensitive layer is preferably 10 μm or more. When the thickness is less than 10 μm, the photosensitive layer may have not enough charging capability and also irregular reflection of laser light for exposure occurs on the surface of the conductive base, and thus interference fringe may occur in a half pattern.

The a-Si photosensitive layer can be formed by a vapor deposition method such as grow discharge decomposition method, sputtering method, ECR method, vacuum deposition method or the like, and the a-Si photosensitive layer can contain H or halogen in the formation process. To control characteristics of the a-Si photosensitive layer, it may contain elements such as C, N or O as well as group 13 elements or group 15 elements of the Periodic Table (long period type)

Specifically, the a-Si photosensitive layer can be formed of various a-Si-based materials having photoconductivity such as a-SiC, a-SiO and a-SiON, in addition to a-Si. It is particularly preferable to use a-SiC. In that case, x of Si₁₋ₓCₓ is preferably set within the following range: 0<x≦0.5, preferably 0.05≦x≦0.45. When x is within the above range, photosensitivity of the a-Si photoreceptor can be improved by increasing resistance of an a-SiC layer than that of an a-Si layer while maintaining good transportation of carriers. As the group 13 elements or group 15 elements, B or P are preferable because they are excellent in covalent and can make semiconductor characteristics more sensible and also enable excellent photosensitivity.

When the a-Si photosensitive layer comprises a layer region having enhanced function of generating optical carrier (optical exciting layer region) and a layer region having a function of transporting carriers (carrier transporting layer region) which are laminated with each other, both photosensitivity and voltage endurance characteristics of the a-Si photoreceptor can be enhanced. In this case, in order to enhance efficiency of production of optical carriers in the optical exciting layer region, it is preferred to form the layer region while taking such measures: (1) the film-forming rate is set to a low rate, (2) the rate of dilution of the film-forming component with H₂ or He is increased, and (3) the amount of the element to be doped is increased as compared with that in case of the carrier transporting layer region.

The carrier transporting layer region mainly plays a role of enhancing a proof voltage of the a-Si photosensitive layer and smoothly transporting carriers injected from the optical exciting layer region into a conductive base. Also in this layer region, carriers are produced by light penetrated through the optical exciting layer region, thus contributing to an improvement in photosensitivity of the a-Si photoreceptor.

The thickness of the a-Si photosensitive layer is preferably 30 μm or less. Particularly preferably, the thickness is a light absorption depth determined from an absorption coefficient of the a-Si photosensitive layer to light having an exposure wavelength plus a thickness within a range from 0.1 to 2.0 μm. When the a-Si photosensitive layer has a layered structure comprising an optical exciting layer region and a carrier transporting layer region which are laminated with each other, as described above, the thickness of the optical exciting layer region is preferably set to the thickness which is almost the same as the light absorption depth.

It is preferred to interpose a carrier blocking layer between the a-Si photosensitive layer and the conductive base. The carrier blocking layer has a function of preventing carries from injecting into the a-Si photosensitive layer from the conductive base when the surface of the a-Si photosensitive layer is contacted with a magnetic toner while applying a bias voltage upon development, thereby to enhance electrostatic contrast between the exposed portion and the non-exposed portion and to improve the image density, and thus fogging is reduced. It is preferably used, as the carrier blocking layer, an inorganic insulating layer formed of insulating a-SiC, a-SiO, a-SiN, a-SiON, a-SiCON or the like, or an organic insulating layer formed of polyethylene terephthalate, parylene®, polyterafluoroethylene, polyimide, fluorinated ethylene propylene copolymer, polyurethane, epoxy resin, polyester, polycarbonate, cellulose acetate or the like.

The carrier blocking layer requires these characteristics such as insulating properties, good adhesion between the conductive base and the a-Si photosensitive layer, and no deterioration caused by heating in case of the formation of the a-Si photosensitive layer. Considering these characteristics, the carrier blocking layer is preferably formed of a-SiC. To provide a-SiC constituting the carrier blocking layer with insulating properties, the content of C in the carrier blocking layer is increased as compared with the case of the a-Si photosensitive layer. The thickness of the carrier blocking layer is preferably from 0.01 to 5 μm, and more preferably from 0.1 to 3 μm.

The surface of the a-Si photosensitive layer is preferably protected with a surface protective layer made of an organic or inorganic insulating material. Consequently, it becomes possible to prevent an oxide film, which easily adsorb discharge products and water molecules, from forming as a result of oxidation of the surface of the a-Si photosensitive layer upon discharging by charging means or the like. It is also possible to improve an isolation voltage and to improve wear resistance when used repeatedly. It is particularly preferred to use a layer made of an a-Si-based insulating material such as a-SiC, a-SiN, a-SiO, a-SiCO, a-SiNO or the like. The layer can be formed by the same thin-film forming method as that used in case of the a-Si photosensitive layer, and is particularly preferably formed of a-SiC.

When a-SiC is used for the surface protective layer, the content of C may be increased as compared with the a-Si photosensitive layer, so as to impart insulating properties, similar to the case of the carrier blocking layer. Specifically, x of Si₁₋ₓCₓ is preferably set within the following range: 0.3≦x<1.0, particularly preferably 0.5≦x≦0.95. The surface protective layer made of a-SiC has high specific resistance within a range from 10¹² to 10¹³ Ω·cm. Therefore, the a-Si photoreceptor comprising an a-Si photosensitive layer whose surface is coated with the surface protective layer causes less potential flow in a facial direction of the surface protective layer, resulting in high maintaining capability of the electrostatic latent image and excellent moisture resistance, and thus the excellent effect of suppressing the occurrence of image blurring due to water absorption.

The high resistance surface protective layer also has a function of preventing injection of electric charges through a magnetic toner due to a bias, thereby to enhance electrostatic contrast between the exposed portion and the non-exposed portion and to deposit a large amount of the magnetic toner on the surface, and thus the density of a toner image is increased and the image density is sufficiently enhanced, and thus fogging is reduced. Furthermore, an isolation voltage of the a-Si photoreceptor can also be enhanced.

In the surface protective layer formed of the other insulating material except for a-SiC, optical carriers are continuously trapped even after the formation of the image and a residual potential may not be surely eliminated in a conventional charge elimination step. However, since the surface protective layer formed of a-SiC has such a property that positive charges from the surface are effectively blocked, but negative charges from the conductive base are penetrated comparatively easily. Therefore, it has an advantage that the residual potential after the formation of the image can be effectively eliminated by a conventional charge elimination step and an image can be continuously formed.

Moreover, the surface protective layer formed of a-SiC is excellent in adhesion with the a-Si photosensitive layer made of a-SiC or the like and is also excellent in wear resistance and environment resistance, it has an advantage that the image can be stably formed for a long time period. In the surface protective layer formed of a-SiC, the content of C may vary in the thickness direction and also the moisture resistance can be further enhanced by incorporating elements such as N, O or Ge, together with C.

The thickness of the surface protective layer is preferably within a range from 5,000 to 20,000Å, and is more preferably from 5,000 to 15,000Å. When the thickness is less than 5,000Å, voltage resistance to flow of negative current from transfer means deteriorates particularly upon transfer of the toner image, and thus the surface protective film may deteriorate at an early stage. On the other hand, when the thickness is more than 20,000Å, productivity of the photoreceptor may be lowered because the film-forming time increases.

The charged potential of the a-Si photosensitive material in case of forming the image is not specifically limited, but it is preferred to charge so as to control a surface potential within a range from +200 to +500 V. When the surface potential is less than +200 V, an image having sufficiently high image density may not be formed because of insufficient developing electric field. On the other hand, when the surface potential is more than +500 V, an image having sufficiently high image density may not be formed because the charging capability becomes insufficient according to the thickness of the photosensitive layer and black dots due to dielectric breakdown may easily occur. There also arises a problem that the amount of ozone generated increases. Considering balance between developing properties and charging capability, the surface potential is preferably within a range from +200 to +300 V.

<Cleaning Means>

As cleaning means for removing a magnetic toner remaining on the surface of an a-Si photosensitive layer of an a-Si photoreceptor, an elastic blade pressed against the surface of the a-Si photosensitive layer is used. As the elastic blade, conventionally known various elastic blades made of a rubber or a soft resin can be employed. Specific examples thereof include elastic blades made of silicone rubber, fluorocarbon rubber, urethane rubber and urethane resin. Considering that the magnetic toner is satisfactorily removed and pressed dents are not formed on the surface of the a-Si photosensitive layer, the elastic blade is preferably pressed against the surface of the a-Si photosensitive layer at a linear pressure within a range from 10 to 50 g/cm.

<<Image Forming Method>>

The image forming method of the present invention characterized by comprising the steps of: forming a thin layer of the magnetic toner of claim 1 on a surface of a developer carrying member that is rotated and that is contained a fixed magnet therein; scattering the magnetic toner on a surface of an a-si photoreceptor comprising a photosensitive layer formed of an a-si for holding an electrostatic latent image from the thin layer in a state where the developer carrying member and the photosensitive layer are opposed to each other with a clearance held therebetween such that the thin layer and the surface of the photosensitive layer are not brought into contact with each other, to develop the electrostatic latent image into a toner image; transferring the toner image thus formed on the surface of a material to be printed; and removing the magnetic toner remaining on the surface of the photosensitive layer after transferring on the surface of the material to be printed, using an elastic blade pressed against the surface of the photosensitive layer.

<Developer Carrying Member>

Usable as the developer carrying member are one composed of various types of materials conventionally known. Particularly, it is preferable that a developer carrying member made of aluminum or stainless steel is used.

<Oters>

In order to hold the electrostatic latent image on the surface of the a-si photosensitive layer, the surface of the a-si photosensitive layer may be uniformly charged using a scorotron charger or the like, as in the conventional example and then exposed by exposure means such as a semiconductor laser or a light-emitting diode, to remove charges in an exposed portion.

In order to transfer a toner image formed on the surface of the a-si photosensitive layer on a surface of a material to be printed, a corona charger, a serrated electrode, a transfer roller, or the like, for example, is used. Particularly, the transfer roller is preferable.

As the transfer roller, a roller composed of a soft foam such as foamed EPDM, for example, is preferable. When the roller composed of the foam is used as the transfer roller, toner that has adhered to the transfer roller enters air bubbles of the foam when paper is jammed, for example, thereby making it possible to prevent the reverse of the material to be printed from being made dirty, for example, when driving is resumed. Consequently, the necessity of cleaning the transfer roller is eliminated, thereby making it possible to reduce initial costs and running costs.

It is preferable that the hardness of the transfer roller composed of the soft foam is 30 to 40 degrees in terms of Ascar C Hardness. When the hardness of the transfer roller is lower than this range, inferior transfer may occur. Conversely, when the hardness of the transfer roller is higher than this range, a nip between the transfer roller and the a-si photosensitive layer is reduced, so that a conveyance force of the material to be printed may be lowered.

It is preferable that the transfer roller is rotated with a line speed difference of 3 to 5% from the surface of the a-si photosensitive layer in a state where it is brought into contact with the surface of the a-si photosensitive layer. When the line speed difference is less than 3%, the transfer properties of the toner image is degraded, so that partial character missing may occur, for example. When the line speed difference exceeds 5%, a slip amount from the surface of the a-si photosensitive layer is increased, so that the shift of a transfer image, so-called jitter may be increased.

### EXAMPLES

<<Examination of Shape of Magnetic Powder I>>

(Measurement of Average Particle Diameter)

The Martin's diameters (diameters corresponding to a circle) of 300 magnetic powders appearing on a picture obtained by magnifying an electron magnetograph (×10000 magnification) taken by a transmission electron microscope four times, and the average value of the measured Martin's diameters was found and taken as the average particle diameter of the magnetic powders.

### Example 1

As a binder resin, a styrene-acrylic resin, wherein a peak of molecular weight distribution among molecular weight distribution measured by gel permeation chromatography exists at a molecular weight of 8,000 and a molecular weight of 130,500 and also a glass transition temperature Tg is 55° C., was used.

The measurement of molecular weight distribution due to gel permeation chromatography of the binder resin was carried out by the following procedure. As a measuring apparatus, high-performance GPG [HLC®-8220GPC, manufactured by TOSOH Corporation] was used. As a column for the measurement, a polystyrene gel column [TSK-GEL® GMHXL, manufactured by TOSOH Corporation] was used after two columns were connected in series. As a detector, a RI detector was used. As a standard sample for making a calibration curve, seven kinds of TSK standard polystyrenes, each showing monodispersed distribution of the molecular weight and having a molecular weight of 3.84×10⁶, 1.09×10⁶, 3.55×10⁵, 1.02×10⁵, 4.39×10⁴, 9.10×10³ and 2.98×10³, manufactured by TOSOH Corporation were

A solution mixture obtained by adding a binder resin, whose molecular weight distribution is measured, to tetrahydrofuran, followed by mixing and further standing for 1 hour, was filtered through a filter [CHROMATODISC® 25N, nonaqueous type, pore size: 0.45 μm, manufactured by Kurabo Industries Ltd.] to remove a solid content, and thus a specimen was obtained. The specimen was adjusted so as to control the concentration of the binder resin to 3 mg/ml.

After a column was stabilized by standing in a heat chamber at 40° C., tetrahydrofuran was flowed in the column at a flow rate of 1 ml/min while maintaining the temperature, and then about 1 μl of the specimen was poured into the column and the measurement was carried out.

Using the above-mentioned seven kinds of TSK standard polystyrenes, a molecular weight distribution curve was determined by calculating based on a relation between the logarithmic value and the number of count (retention time) of the calibration curve made from the measurement results in the same manner. Consequently, it was confirmed that the specimen has a molecular weight distribution peak at a molecular weight of 8,000 and a molecular weight of 130,500, as described above.

Used as the magnetic powder is magnetic powder having an average particle diameter of 0.22 μm, composed of magnetite containing Zn at a ratio of 1.1 atom % to Fe, having the particle shape of a octahedron that is a convex polyhedron surrounded by eight triangles as a basis, each of the vertexes and edges of the octahedron being in a curved surface shape, and having a portion that can be taken as a straight line on the outer periphery of its projected image, as shown in FIGS. 1 to 3.

49 mass parts of the binder resin previously synthesized, 45 mass parts of the magnetic powder, 3 mass parts of Fisher-Tropsch wax (Sasol Wax H1 produced by Sasol Chemcal Industries, Ltd.] serving as a release agent, 3 mass parts of a quaternary ammonium salt [BONTRON P-51 produced by Orient Chemical Industries, Ltd.] serving as a positive charge-controlling agent were mixed using a Henschel mixer, were kneaded using a biaxial extruder, were cooled, and were coarsely ground using a hammer mill. They were then finely ground using a mechanical grinder, and were classified using an air current classifier, to produce magnetic toner having a center particle diameter on the volume basis of 8.0 μm.

### Comparative Example 1

Magnetic toner having a center particle diameter on the volume basis of 8.0 μm was produced in the same manner as that in the example 1 except that used as the magnetic powder was the same amount of magnetic powder, having an average particle diameter of 0.22 μm, composed of magnetite having the same composition as that used in the example 1, having the particle shape of an octahedron that is a convex polyhedron surrounded by eight triangles as a basis, each of the vertexes and edges of the octahedron not being in a curved surface shape.

### Comparative Example 2

Magnetic toner having a center particle diameter on the volume basis of 8.0 μm was produced in the same manner as that in the example 1 except that used as the magnetic powder was the same amount of magnetic powder, having an average particle diameter of 0.24 μm, composed of magnetite having the same composition as that used in the example 1, and having the particle shape of an octahedron that is a convex polyhedron surrounded by eight triangles as a basis, each of the vertexes and edges of the octahedron being in a curved surface shape, and not having a portion that can be taken as a straight line on the outer periphery of its projected image.

### Comparative Example 3

Magnetic toner having a center particle diameter on the volume basis of 8.0 μm was produced in the same manner as that in the example 1 except that used as the magnetic powder was the same amount of magnetic powder, having an average particle diameter of 0.20 μm, composed of magnetite having the same composition as that used in the example 1, having the particle shape of an octahedron that is a convex polyhedron surrounded by eight triangles, each of the vertexes and edges of the octahedron being chamfered at a plane smaller than each of faces constituting the octahedron, as shown in FIG. 6(b) in JP11-153882A (1999).

### Comparative Example 4

Magnetic toner having a center particle diameter on the volume basis of 8.0 μm was produced in the same manner as that in the example 1 except that used as the magnetic powder was the same amount of magnetic powder, having an average particle diameter of 0.20 μm, composed of magnetite having the same composition as that used in the example 1, having the particle shape of a cube, each of the vertexes and edges not being in a curved surface shape.

### Comparative Example 5

Magnetic toner having a center particle diameter on the volume basis of 8.0 μm was produced in the same manner as that in the example 1 except that used as the magnetic powder was the same amount of magnetic powder, having an average particle diameter of 0.20 μm, composed of magnetite having the same composition as that used in the example 1, having the particle shape of a cube, each of the vertexes and edges of the cube being chamfered at a plane smaller than each of faces constituting the cube, as shown in FIG. 6(f) in JP11-153882A (1999).

### Comparative Example 6

Magnetic toner having a center particle diameter on the volume basis of 8.0 μm was produced in the same manner as that in the example 1 except that used as the magnetic powder was the same amount of magnetic powder composed of magnetite having the same composition as that used in the example 1, having the particle shape of a sphere, and having an average particle diameter of 0.22 μm.

1.0 mass part of silica [RA-200H produced by NIPPON AEROSIL CO., LTD.] and 2.0 mass parts of titanium oxide [EC-100 produced by TITAN KOGYO KABUSHIKI KAISHA] were added to 100 mass parts of the magnetic toner in each of the example and the comparative examples, and were mixed using a Henschel mixer, and were then used for a page printer using a magnetic one-component jumping developing system [FS-3830N manufactured by KYOCERA MITA CORPORATION] equipped with an a-si photoreceptor as a photoreceptor to actually form images, to evaluate the following properties.

As the a-Si photoreceptor, an a-Si photoreceptor comprising an a-Si photosensitive layer having a total thickness of 14 μm was used. As the cleaning means, an elastic blade made of a urethane rubber was used. As the developer carrying member, one made of SUS305 having a ten-point average surface roughness Rz of 5.0 μm was used.

(A) Normal Temperature and Normal Humidity Test:

The page printe was caused to stand still for eight hours in a normal temperature and normal humidity environment of a temperature of 20° C. and a relative humidity of 65% RH to stabilize the state thereof, to then evaluate each of the following properties in the same normal temperature and normal humidity environment.

(1) Image Density:

Each of the image density of the first image (initial image) on which a standard pattern having a printing ratio of 5% was image-formed using the page printer and the image density of an image (an image after duration) on which a standard pattern having a printing ratio of 5% was image-formed after an ISO 4% document was continuously image-formed on 300,000 paper sheets were respectively measured using a Macbeth reflection density meter [RD914 manufactured by GretagMacbeth AG]. An image having an image density of not less than 1.30 was estimated to be accepted, and an image having an image density of less than 1.30 was estimated to be rejected.

(2) Fogging:

Respective blank portions of the initial image and the image after duration that have been formed in the foregoing item (1) were observed, to evaluate the presence or absence of fogging on the following basis:
∘: No fogging was found.
Δ: Fogging was slightly found.
x: Strong fogging was found.

(3) State of Thin Film:

Upon formation of an initial image and an image after duration, a thin film of a toner formed on a developer carrying member was observed, to evaluate the state on the following basis:
∘: A beautiful thin layer which is uniform in thickness and is free from defects and unevenness was formed.
Δ: Although irregular thin and thick portions were observed, but no adverse influence was exerted on the formed image.
x: Irregular thin and thick portions were observed and also adverse influence was exerted on the formed image.

(4) Cleaning Properties:

Upon formation of an initial image and an image after duration, periphery of an a-Si photoreceptor and an image formed were observed. In case of observation of the periphery of the a-Si photoreceptor, the presence or absence of the following defects caused by poor cleaning was examined.

(a) Whether or not biting of a toner between an a-Si photosensitive layer and a portion of an elastic blade pressed against the a-si photosensitive layer is observed.

(b) Whether or not a toner component or paper powder adheres to the surface of an a-Si photosensitive layer.

(c) Whether or not scratch exits on the surface of an a-Si photosensitive layer.

In case of observation of the image formed, the presence or absence of image defects caused by poor cleaning such as black stripes was examined. Then, cleaning properties were evaluated on the following basis:
∘: Any defects were not found in the periphery of a photoreceptor and the formed image.
Δ: Defects were found in the periphery of a photoreceptor, but defects were not found in the formed image.
x: Defects were found in the periphery of a photoreceptor and also defects were found in the formed image.

(5) Image Quality

The first image (initial image) on which a photographic document was image-formed using the page printer and an image (an image after duration) on which the same photographic document was image-formed after an ISO 4% document was continuously image-formed on 300,000 paper sheets, and then each image quality was evaluated on the following basis:
∘: The formed image was free from roughness and was uniform and fine.
Δ: The formed image was partially rough and is inferior in uniformity, but was in practice satisfactory.
x: The formed image was entirely rough, non-uniform and coarse.

(6) Microscopic Black Dots:

A page printer was modified so as to select a test mode in which a toner image formed on the surface of an a-Si photosensitive layer is not transferred on a paper and transported to an elastic blade and a normal mode in which a toner image is transferred to a paper.

Using this modified apparatus, an operation of selecting the test mode, forming an electrostatic latent image corresponding to a solid black pattern on the surface of an a-Si photosensitive layer, developing the electrostatic latent image into a toner image, transporting the toner image to an electric blade without being transferred on a paper, and removing it from the surface of the a-Si photosensitive layer was continuously performed 50,000 times. Subsequently, after selecting the normal mode, a white paper document (if there is no abnormality in an a-Si photosensitive layer, a toner does not adhere on the surface of the a-Si photosensitive layer in the developing step) was image-formed on a paper.

Then, the number of microscopic black dots produced by deposition of a toner at the portion of defects caused by dielectric breakdown of the a-Si photosensitive layer in the developing step, which were found on the formed image, was counted using a dot analyzer [DA-5000S manufactured by Oji Scientific Instruments]. The number of microscopic black dots was counted in the area measuring 5 mm ×210 mm in a width direction of an A4-sized paper.
∘: The number of microscopic black dots was 0.
Δ: The number of microscopic black dots was from 1 to 20. Since the appearance of the image whose number of microscopic black dots is within this range corresponds to the range from ∘ to Δ of fogging test above-mentioned, it was judged that a conventional formed image is scarcely affected.
x: The number of microscopic black dots was from 20 to 1,000. Regarding the appearance of the image, a large amount of microscopic black dots were produced and seemed to be a black zone, and therefore it was judged that a conventional formed image is affected.
xx: The number of microscopic black dots was 1001 or more. Since a larger amount of microscopic black dots were produced compared with the above-mentioned case, the following high-temperature and high-humidity test and low-temperature and low-humidity test were not performed.

(B) High-temperature and High-humidity Test:

The same page printer used in the normal-temperature and normal-humidity test was caused to stand still for eight hours in a high-temperature and high-humidity environment of temperature of 33° C. and a relative humidity of 85% RH to stabilize the state thereof, and then the respective tests in the items (1) to (6) previously described in the same high-temperature and high-humidity environment as well as the following image blurring test were conducted, to evaluate characteristics.

(7) Image Blurring:

Using the above-mentioned page printer, an ISO 4% document was continuously image-formed on 5,000 paper sheets in the same high-temperature and high-humidity environment, and caused to stand still for twelve hours to stabilize the state thereof, and then documents of half-tones and letters were image-formed and the formed image was observed. The presence or absence of image blurring on the formed image was evaluated on the following basis:
∘: Image blurring was not observed, and both half-tones and letters were satisfactorily reproduced.
Δ: Image blurring was in a permissible range and slight blur was observed in letters.
x: Severe image blurring was observed, and half-tones were eliminated and letters blurred.

(C) Low-temperature and Low-humidity Test:

The same page printer used in the normal-temperature and normal-humidity test was caused to stand still for eight hours in a low-temperature and low-humidity environment of a temperature of 10° C. and a relative humidity of 20% RH to stabilize the state thereof, and then the respective tests in the items (1) to (6) previously described in the same low-temperature and low-humidity environment.

The foregoing results are shown in Tables 1 to 6. Reference signs in columns listing the respective shapes of particles composing the magnetic powder in the Tables are as follows:

Octahedron-round: magnetic powder having the shape of an octahedron, whose vertexes and edges are each in a curved surface shape, and having a portion that can be taken as a straight line on the outer periphery of its projected image.

Octahedron-corner: magnetic powder having the shape of an octahedron, whose vertexes and edges are not each in a curved surface shape. A normal octahedron.

Octahedron-large round: magnetic powder having the shape of an octahedron, whose vertexes and edges are each in a curved surface shape, and not having a portion that can be taken as a straight line on the outer periphery of its projected image because the radii of curvature of a curved surface is too large.

Octahedron-chamfer: magnetic powder having the shape of an octahedron, whose vertexes and edges are each chamfered at a small plane.

Cube-corner: magnetic powder having a cubic shape whose vertexes and edges are not each in a curved surface shape. A normal cube.

Cube-chamfer: magnetic powder having the shape of a cube, whose vertexes and edges are each chamfered at a small plane.

Sphere: the shape of a sphere.

TABLE 1

| | | Normal temperature and normal humidity test | | | | |
|---|---|---|---|---|---|---|
| | Magnetic | (Temperature 20° C., relative humidity 65% RH) | | | | |
| | power | Image density | | Fogging | | |
| | particle | At | After | At | After | Microscopic |
| | shape | beginning | duration | beginning | duration | black dot |
| Example 1 | Octahedron- | 1.40 | 1.41 | ◯ | ◯ | ◯ |
| | round | | | | | |
| Comparative | Octahedron- | 1.01 | 1.11 | Δ | X | ◯ |
| example 1 | corner | | | | | |
| Comparative | Octahedron- | 1.40 | 1.29 | ◯ | ◯ | X |
| example 2 | large round | | | | | |
| Comparative | Octahedron- | 1.10 | 1.18 | Δ | X | ◯ |
| example 3 | chamfer | | | | | |
| Comparative | Cube-corner | 1.15 | 1.22 | Δ | X | ◯ |
| example 4 | | | | | | |
| Comparative | Cube-chamfer | 1.18 | 1.25 | Δ | X | ◯ |
| example 5 | | | | | | |
| Comparative | Sphere | 1.38 | 1.05 | ◯ | X | XX |
| example 6 | | | | | | |

TABLE 2

| | | Normal temperature and normal humidity test | | | | | |
|---|---|---|---|---|---|---|---|
| | Magnetic | (Temperature 20° C., relative humidity 65% RH) | | | | | |
| | power | State of thin film | | Cleaning property | | Image quality | |
| | particle | At | After | At | After | At | After |
| | shape | beginning | duration | beginning | duration | beginning | duration |
| Example 1 | Octahedron- | ◯ | ◯ | ◯ | ◯ | ◯ | ◯ |
| | round | | | | | | |
| Comparative | Octahedron- | ◯ | ◯ | Δ | Δ | X | X |
| example 1 | corner | | | | | | |
| Comparative | Octahedron- | ◯ | ◯ | ◯ | ◯ | ◯ | ◯ |
| example 2 | large round | | | | | | |
| Comparative | Octahedron- | ◯ | ◯ | Δ | X | X | X |
| example 3 | chamfer | | | | | | |
| Comparative | Cube-corner | ◯ | ◯ | Δ | Δ | X | Δ |
| example 4 | | | | | | | |
| Comparative | Cube-chamfer | ◯ | ◯ | Δ | Δ | X | Δ |
| example 5 | | | | | | | |
| Comparative | Sphere | ◯ | Δ | Δ | X | ◯ | X |
| example 6 | | | | | | | |

TABLE 3

| | | High temperature and high humidity test | | | | |
|---|---|---|---|---|---|---|
| | Magnetic | (Temperature 33° C., relative humidity 85% RH) | | | | |
| | power | Image density | | Fogging | | |
| | particle | At | After | At | After | Microscopic |
| | shape | beginning | duration | beginning | duration | black dot |
| Example 1 | Octahedron- | 1.38 | 1.41 | ◯ | ◯ | ◯ |
| | round | | | | | |
| Comparative | Octahedron- | 0.90 | 1.08 | Δ | X | ◯ |
| example 1 | corner | | | | | |
| Comparative | Octahedron- | 1.35 | 1.27 | ◯ | ◯ | Δ |
| example 2 | large round | | | | | |
| Comparative | Octahedron- | 1.05 | 1.15 | Δ | X | ◯ |
| example 3 | chamfer | | | | | |
| Comparative | Cube-corner | 1.06 | 1.18 | Δ | X | ◯ |
| example 4 | | | | | | |
| Comparative | Cube-chamfer | 1.10 | 1.22 | Δ | X | ◯ |
| example 5 | | | | | | |
| Comparative | Sphere | 1.37 | 1.02 | ◯ | X | X |
| example 6 | | | | | | |

TABLE 4

| | | High temperature and high humidity test | | | | | | |
|---|---|---|---|---|---|---|---|---|
| | Magnetic | (Temperature 33° C., relative humidity 85% RH) | | | | | | |
| | power | State of thin film | | Cleaning property | | Image quality | | |
| | particle | At | After | At | After | At | After | Image |
| | shape | beginning | duration | beginning | duration | beginning | duration | blurring |
| Example 1 | Octahedron- | ◯ | ◯ | ◯ | ◯ | ◯ | ◯ | ◯ |
| | round | | | | | | | |
| Comparative | Octahedron- | ◯ | ◯ | Δ | Δ | X | X | ◯ |
| example 1 | corner | | | | | | | |
| Comparative | Octahedron- | ◯ | ◯ | ◯ | ◯ | ◯ | Δ | Δ |
| example 2 | large round | | | | | | | |
| Comparative | Octahedron- | ◯ | ◯ | Δ | Δ | X | X | ◯ |
| example 3 | chamfer | | | | | | | |
| Comparative | Cube-corner | ◯ | ◯ | Δ | X | X | X | ◯ |
| example 4 | | | | | | | | |
| Comparative | Cube-chamfer | ◯ | ◯ | Δ | X | X | X | ◯ |
| example 5 | | | | | | | | |
| Comparative | Sphere | ◯ | Δ | X | X | ◯ | X | X |
| example 6 | | | | | | | | |

TABLE 5

| | | Low temperature and low humidity test | | | | |
|---|---|---|---|---|---|---|
| | Magnetic | (Temperature 10° C., relative humidity 20% RH) | | | | |
| | power | Image density | | Fogging | | |
| | particle | At | After | At | After | Microscopic |
| | shape | beginning | duration | beginning | duration | black dot |
| Example 1 | Octahedron- | 1.41 | 1.43 | ◯ | ◯ | ◯ |
| | round | | | | | |
| Comparative | Octahedron- | 1.20 | 1.23 | Δ | X | ◯ |
| example 1 | corner | | | | | |
| Comparative | Octahedron- | 1.35 | 1.23 | ◯ | ◯ | X |
| example 2 | large round | | | | | |
| Comparative | Octahedron- | 1.24 | 1.28 | Δ | X | ◯ |
| example 3 | chamfer | | | | | |
| Comparative | Cube-corner | 1.18 | 1.20 | Δ | X | ◯ |
| example 4 | | | | | | |
| Comparative | Cube-chamfer | 1.16 | 1.26 | Δ | X | ◯ |
| example 5 | | | | | | |
| Comparative | Sphere | — | — | — | — | — |
| example 6 | | | | | | |

TABLE 6

| | | Low temperature and low humidity test | | | | | |
|---|---|---|---|---|---|---|---|
| | Magnetic | (Temperature 10° C., relative humidity 20% RH) | | | | | |
| | power | State of thin film | | Cleaning property | | Image quality | |
| | particle | At | After | At | After | At | After |
| | shape | beginning | duration | beginning | duration | beginning | duration |
| Example 1 | Octahedron- | ◯ | ◯ | ◯ | ◯ | ◯ | ◯ |
| | round | | | | | | |
| Comparative | Octahedron- | ◯ | ◯ | Δ | Δ | X | X |
| example 1 | corner | | | | | | |
| Comparative | Octahedron- | ◯ | Δ | ◯ | ◯ | ◯ | ◯ |
| example 2 | large round | | | | | | |
| Comparative | Octahedron- | ◯ | ◯ | Δ | X | X | X |
| example 2 | chamfer | | | | | | |
| Comparative | Cube-corner | ◯ | ◯ | Δ | X | X | X |
| example 4 | | | | | | | |
| Comparative | Cube-chamfer | ◯ | ◯ | Δ | X | X | X |
| example 5 | | | | | | | |
| Comparative | Sphere | — | — | — | — | — | — |
| example 6 | | | | | | | |

It was confirmed from Tables proved that in both magnetic toner in the comparative example 1 using the magnetic powder having the shape of an octahedron, whose vertexes and edges are not each in a curved surface shape and magnetic toner in the comparative example 3 using the magnetic powder having the shape of an octahedron, whose vertexes and edges are each chamfered at a small plane, the initial charging amount was significantly small, the image density was low, fogging was produced, and fogging after duration was significantly degraded in the test under all environments, so that charged charges of the toner leaked.

Furthermore, it was confirmed that in both magnetic toner in the comparative example 4 using the magnetic powder having the shape of a cube, whose vertexes and edges are not each in a curved surface shape, and magnetic toner in the comparative example 5 using the magnetic powder having the shape of a cube, whose vertexes and edges are each chamfered at a small plane, the initial charging amount was significantly small, the image density was low, fogging was produced, and fogging after duration was significantly degraded similarly in the test under all environments, so that charged charges of the toner leaked.

Furthermore, it was confirmed that in both magnetic toner in the comparative example 2 using the magnetic powder having the shape of an octahedron, whose vertexes and edges are each in a curved surface shape but not having a portion that can be taken as a straight line on the outer periphery of its projected image because the radii of curvature of a curved surface is too large and magnetic toner in the comparative example 6 using the spherical magnetic powder, the image density after duration was lowered, and fogging was produced in the normal temperature and normal humidity test and the high-temperature and high-humidity test, so that charge-up was produced. When the magnetic toner in the comparative example 6 using the spherical magnetic powder was used, the image had already been non-uniform at the beginning in the low-temperature and low-humidity test. When the cause was examined, it was determined that the thin layer of toner was not uniformly formed on the surface of the developer carrying member. Therefore, durability evaluation was not performed.

In the normal-temperature and normal-humidity environment test, when the magnetic toner of the comparative example 6 is used, very large amount of microscopic black dots were produced in the formed image. Also when the magnetic toner of the comparative example 2 is used, microscopic black dots were produced in a large amount, which is not suited for practical use, although the amount is not more than that in case of the magnetic toner of the comparative example 6. Consequently, it was confirmed that, when the magnetic toners of the comparative examples 2 and 6 were used, charge-up occurred to cause dielectric breakdown of the a-Si photosensitive layer.

On the other hand, it was confirmed that in magnetic toner in the example 1 using the magnetic powder having the shape of an octahedron, whose vertexes and edges are each in a curved surface shape, and having a portion that can be taken as a straight line on the outer periphery of its projected image, it was possible to keep image densities at the beginning and after duration approximately constant as well as to form a good image for a long time period under a wide environment by preventing leakage of charges and also preventing dielectric breakout of the a-si, photosensitive layer due to charge-up because of free from fogging and microscopic black dots in all the normal temperature and normal humidity test, the low-temperature and low-humidity test, and the high-temperature and high-humidity test.

<<Examination of Shape of Magnetic Powder II>>

### Examples 2 to 5, Comparative Examples 7 and 8

Magnetic toner having a center particle diameter on the volume basis of 8.0 μm was produced in the same manner as that in the example 1 except that used as the magnetic powder was the same amount of magnetic powders respectively having average particle diameters of 0.006 μm (comparative example 7), 0.016 μm (example 2), 0.083 μm (example 3), 0.33 μm (example 4), 0.39 μm (example 5), and 0.64 μm (comparative example 8), composed of magnetite having the same composition as that used in the example 1, having the particle shape of an octahedron that is a convex polyhedron surrounded by eight triangles as a basis, whose vertexes and edges are each in a curved surface shape, and having a portion that can be taken as a straight line on the outer periphery of its projected image.

1.0 mass part of silica [RA-200H produced by NIPPON AEROSIL CO., LTD.] and 2.0 mass parts of titanium oxide [EC-100 produced by TITAN KOGYO KABUSHIKI KAISHA] were added to 100 mass parts of the magnetic toner in each of the example and the comparative examples, and were mixed using a Henschel mixer, and were then used for a page printer using a magnetic one-component jumping developing system [FS-3830N manufactured by KYOCERA MITA CORPORATION] equipped with an a-si photoreceptor as a photoreceptor to actually form images, to evaluate the properties previously described.

As the a-Si photoreceptor, an a-Si photoreceptor comprising an a-Si photosensitive layer having a total thickness of 14 μm was used. As the cleaning means, an elastic blade made of a urethane rubber was used. As the developer carrying member, one made of SUS305 having a ten-point average surface roughness Rz of 5.0 μm was used.

The results, together with the results in the example 1, are shown in Tables 7 to 12:

TABLE 7

| | | Normal temperature and normal humidity test | | | | |
|---|---|---|---|---|---|---|
| | average | (Temperature 20° C., relative humidity 65% RH) | | | | |
| | particle | Image density | | Fogging | | |
| | diameter | | After | | After | Microscopic |
| | (μm) | At beginning | duration | At beginning | duration | black dot |
| Comparative | 0.006 | 1.18 | 1.36 | Δ | ◯ | X |
| example 7 | | | | | | |
| Example 2 | 0.016 | 1.33 | 1.37 | ◯ | ◯ | Δ |
| Example 3 | 0.083 | 1.38 | 1.39 | ◯ | ◯ | ◯ |
| Example 1 | 0.22 | 1.40 | 1.41 | ◯ | ◯ | ◯ |
| Example 4 | 0.33 | 1.42 | 1.38 | ◯ | ◯ | ◯ |
| Example 5 | 0.39 | 1.41 | 1.33 | ◯ | ◯ | ◯ |
| Comparative | 0.64 | 1.38 | 1.20 | ◯ | X | X |
| example 8 | | | | | | |

TABLE 8

| | | Normal temperature and normal humidity test | | | | | |
|---|---|---|---|---|---|---|---|
| | average | (Temperature 20° C., relative humidity 65% RH) | | | | | |
| | particle | State of thin film | | Cleaning property | | Image quality | |
| | diameter | At | After | At | After | At | After |
| | (μm) | beginning | duration | beginning | duration | beginning | duration |
| Comparative | 0.006 | ◯ | ◯ | Δ | X | X | ◯ |
| example 7 | | | | | | | |
| Example 2 | 0.016 | ◯ | ◯ | ◯ | ◯ | ◯ | ◯ |
| Example 3 | 0.083 | ◯ | ◯ | ◯ | ◯ | ◯ | ◯ |
| Example 1 | 0.22 | ◯ | ◯ | ◯ | ◯ | ◯ | ◯ |
| Example 4 | 0.33 | ◯ | ◯ | ◯ | ◯ | ◯ | ◯ |
| Example 5 | 0.39 | ◯ | ◯ | ◯ | ◯ | ◯ | ◯ |
| Comparative | 0.64 | ◯ | ◯ | X | X | ◯ | X |
| example 8 | | | | | | | |

TABLE 9

| | | High temperature and high humidity test | | | | |
|---|---|---|---|---|---|---|
| | average | (Temperature 33° C., relative humidity 85% RH) | | | | |
| | particle | Image density | | Fogging | | |
| | diameter | | After | | After | Microscopic |
| | (μm) | At beginning | duration | At beginning | duration | black dot |
| Comparative | 0.006 | 1.18 | 1.25 | Δ | ◯ | X |
| example 7 | | | | | | |
| Example 2 | 0.016 | 1.35 | 1.39 | ◯ | ◯ | ◯ |
| Example 3 | 0.083 | 1.37 | 1.36 | ◯ | ◯ | ◯ |
| Example 1 | 0.22 | 1.38 | 1.41 | ◯ | ◯ | ◯ |
| Example 4 | 0.33 | 1.42 | 1.41 | ◯ | ◯ | ◯ |
| Example 5 | 0.39 | 1.40 | 1.37 | ◯ | ◯ | ◯ |
| Comparative | 0.64 | 1.39 | 1.18 | ◯ | ◯ | X |
| example 8 | | | | | | |

TABLE 10

| | | High temperature and high humidity test | | | | | | |
|---|---|---|---|---|---|---|---|---|
| | average | (Temperature 33° C., relative humidity 85% RH) | | | | | | |
| | particle | State of thin film | | Cleaning property | | Image quality | | |
| | diameter | At | After | At | At | After | At | Image |
| | (μm) | beginning | duration | beginning | beginning | duration | beginning | blurring |
| Comparative | 0.006 | ◯ | ◯ | Δ | X | X | Δ | Δ |
| example 7 | | | | | | | | |
| Example 2 | 0.016 | ◯ | ◯ | ◯ | ◯ | ◯ | ◯ | ◯ |
| Example 3 | 0.083 | ◯ | ◯ | ◯ | ◯ | ◯ | ◯ | ◯ |
| Example 1 | 0.22 | ◯ | ◯ | ◯ | ◯ | ◯ | ◯ | ◯ |
| Example 4 | 0.33 | ◯ | ◯ | ◯ | ◯ | ◯ | ◯ | ◯ |
| Example 5 | 0.39 | ◯ | ◯ | ◯ | ◯ | ◯ | ◯ | ◯ |
| Comparative | 0.64 | ◯ | ◯ | Δ | Δ | ◯ | X | X |
| example 8 | | | | | | | | |

TABLE 11

| | | Low temperature and low humidity test | | | | |
|---|---|---|---|---|---|---|
| | average | (Temperature 10° C., relative humidity 20% RH) | | | | |
| | particle | Image density | | Fogging | | |
| | diameter | | After | | After | Microscopic |
| | (μm) | At beginning | duration | At beginning | duration | black dot |
| Comparative | 0.006 | 1.21 | 1.27 | X | X | X |
| example 7 | | | | | | |
| Example 2 | 0.016 | 1.35 | 1.40 | ◯ | ◯ | Δ |
| Example 3 | 0.083 | 1.39 | 1.38 | ◯ | ◯ | ◯ |
| Example 1 | 0.22 | 1.41 | 1.43 | ◯ | ◯ | ◯ |
| Example 4 | 0.33 | 1.42 | 1.41 | ◯ | ◯ | ◯ |
| Example 5 | 0.39 | 1.41 | 1.34 | ◯ | ◯ | ◯ |
| Comparative | 0.64 | 1.38 | 1.08 | ◯ | X | X |
| example 8 | | | | | | |

TABLE 12

| | | Low temperature and low humidity test | | | | | |
|---|---|---|---|---|---|---|---|
| | average | (Temperature 10° C., relative humidity 20% RH) | | | | | |
| | particle | State of thin film | | Cleaning property | | Image quality | |
| | diameter | At | After | At | At | After | At |
| | (μm) | beginning | duration | beginning | beginning | duration | beginning |
| Comparative | 0.006 | ◯ | ◯ | X | X | X | X |
| example 7 | | | | | | | |
| Example 2 | 0.016 | ◯ | ◯ | ◯ | ◯ | ◯ | ◯ |
| Example 3 | 0.083 | ◯ | ◯ | ◯ | ◯ | ◯ | ◯ |
| Example 1 | 0.22 | ◯ | ◯ | ◯ | ◯ | ◯ | ◯ |
| Example 4 | 0.33 | ◯ | ◯ | ◯ | ◯ | ◯ | ◯ |
| Example 5 | 0.39 | ◯ | ◯ | ◯ | ◯ | ◯ | ◯ |
| Comparative | 0.64 | ◯ | ◯ | Δ | Δ | X | X |
| example 8 | | | | | | | |

It was confirmed from Tables that in magnetic toner in the comparative example 7 using the magnetic powder having the shape of an octahedron, whose vertexes and edges are each in a curved surface shape, and having a portion that can be taken as a straight line on the outer periphery of its projected image, while having an average particle diameter of less than 0.01 μm, the initial image density was below 1.30 in each of the tests under the environments, the image density after duration was below 1.30 in the normal temperature and normal humidity test and high-temperature and the high-humidity test. Further, fogging was produced in the high-temperature and high-humidity test. When the cause was examined, it was determined that the ratio at which the magnetic powder was exposed to the surfaces of the toner particles was increased, and charges were discharged from the exposed magnetic powder, causing deficiency in charging of the magnetic toner.

It was also confirmed that, since microscopic black dots were produced, charge-up occurred to cause dielectric breakdown of the a-Si photosensitive layer. This cause was considered that a magnetic toner wherein a magnetic powder is non-uniformly distributed in toner particles and a magnetic toner having very small content of a magnetic powder are produced because of poor dispersibility of the magnetic powder. It is assumed that, when these magnetic toners are rubbed with the elastic blade or the a-Si photosensitive layer, charge-up occurred to cause discharging that enables dielectric breakdown of the a-Si photosensitive layer.

It was confirmed that in magnetic toner in the comparative example 8 using the magnetic powder having the shape of an octahedron, whose vertexes and edges are each in a curved surface shape, having a portion that can be taken as a straight line on the outer periphery of its projected image, while having an average particle diameter in excess of 0.50 μm, the image density after duration was lowered, and fogging was produced in each of the tests under the environments, so that charge-up occurred. It was also confirmed that, since a large number of microscopic black dots were produced, charge-up occurred to cause dielectric breakdown of the a-Si photosensitive layer. When the cause was examined, it was determined that the ratio at which the magnetic powder was exposed to the surfaces of the toner particles was decreased, and charges discharged from the exposed magnetic powder were reduced.

On the other hand, it was confirmed that in the magnetic toner in each of the examples 1 to 5 using the magnetic powder having the shape of an octahedron, whose vertexes and edges are each in a curved surface shape, having a portion that can be taken as a straight line on the outer periphery of its projected image, and having an average particle diameter of 0.01 to 0.50 μm, it was possible to keep image densities at the beginning and after duration approximately constant as well as to form a good image for a long time period under a wide environment by preventing leakage of charges and also preventing dielectric breakout of the a-si photosensitive layer due to charge-up because of free from fogging and microscopic black dots in all the normal temperature and normal humidity test, the low-temperature and low-humidity test, and the high-temperature and high-humidity test.

When the examples were compared, it was confirmed from the change of the image density that the average particle diameter of the magnetic powder was preferably 0.05 to 0.35 μm and more preferably 0.15 to 0.30 μm.

This application corresponds to Japanese Patent Application No.2004-296902 filed with the Japanese Patent Office on Oct. 8, 2004, the disclosure of which is incorporated herein by reference.

What is claimed is:

1. Magnetic toner to be used for an image forming method comprising the step of using an amorphous silicon photoreceptor comprising a photosensitive layer formed of an amorphous silicon for holding an electrostatic latent image on the surface, which is used to develop an electrostatic latent image held on the surface of the photosensitive layer into a toner image and to transfer the toner image on the surface of a material to be printed to form an image, and an elastic blade pressed against the surface of the photosensitive layer so as to remove a toner remaining on the surface of the photosensitive layer after forming the image, wherein characterized in that
toner particles formed of binder resin involves magnetic powder having an average particle diameter of 0.01 to 0.5 μm, and having the particle shape of an octahedron that is a convex polyhedron surrounded by eight triangles as a basis, each of the vertexes and edges of the octahedron being in a curved surface shape, and having a portion that can be taken as a straight line on the outer periphery of its projected image.

2. The magnetic toner according to claim 1, wherein
the average particle diameter of the magnetic powder is 0.05 to 0.35 μm.

3. The magnetic toner according to claim 1, wherein
the magnetic powder is formed of magnetite containing at least one type of element selected from Mn, Zn, Ni, Cu, Al, Ti, and Si that is 0.1 to 10 atom % of Fe.

4. The magnetic toner according to claim 1, wherein
the content of the magnetic powder is 35 to 65 mass %.

5. The magnetic toner according to claim 1, which is used for an image forming, method of using an amorphous silicon photoreceptor comprising a photosensitive layer having a thickness of 30 μm or less.

6. An image forming method characterized by comprising the steps of:
forming a thin layer of the magnetic toner of claim 1 on a surface of a developer carrying member that is rotated and that is contained a fixed magnet therein;
scattering the magnetic toner on a surface of an amorphous silicon photoreceptor comprising a photosensitive layer formed of an amorphous silicon for holding an electrostatic latent image from the thin layer in a state where the developer carrying member and the photosensitive layer are opposed to each other with a clearance held therebetween such that the thin layer and the surface of the photosensitive layer are not brought into contact with each other, to develop the electrostatic latent image into a toner image;
transferring the toner image thus formed on the surface of a material to be printed; and
removing the magnetic toner remaining on the surface of the photosensitive layer after transferring on the surface of the material to be printed, using an elastic blade pressed against the surface of the photosensitive layer.

7. The image forming method according to claim 6, wherein an amorphous silicon photoreceptor comprising a photosensitive layer having a thickness of 30 μm or less is used as the amorphous silicon photoreceptor.
